(19) United States
(12) Patent Application Publication
(10) Pub. No.: US 2021/0195826 A1
(43) Pub. Date: Jul. 1, 2021

(54) Vehicle with Trailer Operatively Connected Thereto With a Cardan

(71) Applicants: Pierangelo Vercellino, Alice Bel Colle (IT); Valerio Raganelli, Prasco (IT)

(72) Inventors: Pierangelo Vercellino, Alice Bel Colle (IT); Valerio Raganelli, Prasco (IT)

(21) Appl. No.: 16/071,242

(22) PCT Filed: Jan. 18, 2017
(86) PCT No.: PCT/IB2017/050265

§ 371 Date: Jul. 19, 2018

(30) Foreign Application Priority Data
Jan. 19, 2016 (IT) 102016000004445

(51) Int. Cl. A01B 71/06; B60D 1/145; B60K 25/06; A01B 61/02

(52) U.S. Cl. CPC A01B 71/066; A01B 61/025; B60K 25/06; B60D 1/145

(57) ABSTRACT

Disclosed herein is vehicle (1) with trailer (2) operatively connected thereto with a cardan (3), said cardan (3) comprising a power take-off, said power take-off being switched off when said cardan (3) forms with said vehicle (1) and/or with said trailer (2) an angle (α; β) smaller than a first threshold value and/or larger than a second threshold value and being switched on when said angle exceeds again said first threshold value or goes below said other threshold value, due to suitable actuators. According to the invention, it provides angle (δ) detection means between the steering wheels (5) and the axle (A) of the vehicle and means apt to correlate said angle (δ) between the steering wheels (5) and the axle (A) of the vehicle (1) with the angle (α; β) comprised between the cardan (3) and said vehicle (1) and/or said trailer (2).

The present invention relates to a vehicle with a trailer, operatively connected thereto with a cardan, in particular, although not exclusively, to a tractor, which tows an agricultural machine, such as a sprayer or a lawn mower.

In prehistoric times, the human beings began to eat exploiting what the nature spontaneously provided to them. Thus, they could eat fruits and mushrooms or roots. In addition, a widely practised activity was the hunting of animals deemed to be most suitable. This way of eating meant that the man had to move frequently in search of new animals and new fruits, when those naturally present in a zone ran out or were reduced excessively to meet the needs.

As time elapsed, the man realised that the accidental fall of seeds from a fruit led to the birth of a plant, able to bring those same fruits again, so he began to systematically cultivate the soil and ceased to live as a nomad, and adapted mostly to a sedentary lifestyle. Since then, agriculture is the main activity by which man, even today, obtains food.

In order to achieve significant results, agriculture requires many operations, in addition to planting and harvesting. Indeed, it is necessary to prepare the soil for planting by plowing and tilling it, remove weeds that could hinder the growth of the cultivated plants (especially in the early stages of their development), prune the static plants in the period when there are no leaves, fertilise the soil, spray the leaves and fruits with substances against parasites, and so on. At first, all these operations were carried out by hand (as still happens in some poor countries), by means of rudimentary tools, such as hand plows, hoes and the like. Next, animals were utilised for performing these operations. For example, the plow was, until about a century ago, transported mostly by oxen. With the advent of the internal combustion engine, the oxen have been almost completely replaced by tractors that can move, by means of very large wheels or tracks, even on rough ground, often carrying very heavy loads.

The tractor is very often used to tow trailers for the most varied uses. In particular, tractors are used often to tow other agricultural machines, for example to fertilise the soil, to spray the leaves or to cut excessively long branches or the grass. Normally, the tractor-drawn machines require to be powered to operate. To avoid installing independent motors on these machines, for example other internal combustion engines or electric motors, which would require independent power supply and which would imply, considering the yields obviously below 100% for each of them, a substantial energy waste, the so-called power take-off has been developed. The power take-off consists of a mechanical connection between tractor and trailer, which allows to apply, by turning under the action of the engine of the tractor, to towed machines the mechanical energy developed by the engine of the tractor, so as to exploit more in depth the energy that actuates the tractor.

Commonly, the power take-off is constituted by a rod, rotated by the engine of the tractor through a protrusion of the transmission shaft of the tractor, and which transmits the same rotation to a drive shaft of the driven machine. For example, in this way it is possible to operate a pump for spraying liquids or for fertilising.

Normally, the rod of the power take-off is realised with a cardan that allows the transmission of the curve of the tractor to the trailer, allowing under certain circumstances to maintain the rotation of the rod and the power transmission. The most common power take-offs allow rotation speeds even high, for example between 500 and 1000 rpm. Most power take-offs have a rotation speed of 540 rpm or 1,000 rpm, or have the possibility to select one of these two speeds. Some of the most advanced tractor models provide the proportionality of the rotation of the cardan to the speed of the engine of the tractor.

In the agricultural practice, it is common to use such machines in fields realised in rows. For example, when there is a need of spraying the verdigris on the grapevines, it is necessary to move a tractor along the rows, towing by the tractor a trailer with a verdigris tank, a pump which draws from the tank and spraying nozzles, which are fed by the pump. The pump is kept in operation by the power take-off of the tractor. At the end of the row, the tractor and the trailer must be rotated by 180° to turn around the end of the row and to start spraying the next row. This operation, although conceptually very simple, has a problem with the power take-off, in addition to the normal difficulties on the agricultural lands, which are typically quite uneven and often steep. Indeed, by the very nature of the cardan, it can work correctly with angles with the tractor and/or the trailer with up to about 35°; a curve that results in the creation of smaller angles between the vehicle and the cardan causes the breakage of the cardan, with the stop of the ongoing operation and a long and costly replacement. For this reason, the operator who drives the tractor, once arrived at the end of the row, must manually disengage the power take-off, thus suspending the rotation of the cardan, perform the conversion and, when the curve is over and the angle returns to about 90°, engage again the power take-off, thereby restoring the rotation of the cardan and recovering at full capacity the ongoing operation.

Driving a tractor is a rather complicated operation and requires to pay an uncommon attention to the ground, which is uneven and sometimes dangerous, to pay attention to the speed, which must be adapted to the ground type and the ongoing operation, to pay attention to the processing itself, and to pay attention to avoid excessive slopes. Therefore, the addition of the engagement and disengagement operations of the power takeoff adds to a number of other operations that require considerable attention by the operator and that can thus be easily forgotten. As said above, forgetting to disengage the power take-off leads to the breaking of the cardan, while forgetting to engage it again causes the tractor to continue its path, consuming time and fuel, without continuing its work, so that the work is bad performed or it must be repeated. Moreover, the attention to engage and disengage the power take-off could distract the attention of the operator from other attentions, and it could be ultimately dangerous for him.

The U.S. Pat. No. 5,320,186 discloses a system for changing the position and the speed of a connection for the power take-off in a tractor with a carried tool. The term “carried tool” means that the tool is carried on the hydraulic lifting device of the tractor. Carried loads and trailed loads have very different features between each other. The operator while driving can raise or lower the attachment position to attack a trailer tool. The attachment position and, as a consequence, the speed of the same are detected. By means of an algorithm, the error of the speed measurement is calculated and, based on the result, the attachment is raised or lowered via a solenoid valve. The system records the optimum values, so as to accelerate the calculations. Finally, a potentiometer for the speed drop allows to obtain the desired speed. This system is very useful, but it still requires the fully conscious and voluntary action by the operator for the disengagement and engagement of the power take-off.

GB 1 088 954 discloses an energy transmission through a shaft assembly, to be connected to the power take-off of a tractor by means of a universal joint, with a resilient suspension system on the joint, so as to allow a movement without obstacles.

WO99/56 978 discloses a process for the control of a cardan for the power transmission. It provides an insertion/exclusion valve of the cardan. Through this valve, the cardan can be inserted/excluded.

US2014/0 303 849 discloses a method for detecting the position of a trailer with respect to a vehicle. In this way, the trajectory that can then be inserted in a curvature control device is determined.

A similar situation can occur with vehicles other than farm vehicles, which however comprise a power take-off.

Problem underlying the invention is to propose a vehicle with a trailer, operatively connected thereto with a cardan, which overcomes the above-mentioned disadvantages, and which allows the automatic engagement and disengagement of the power take-off when the angle between said cardan and said vehicle and/or said trailer exceeds a threshold value. This object is achieved through a vehicle with trailer operatively connected thereto with a cardan, said cardan comprising a power take-off, said power take-off being switched off when said cardan forms with said vehicle and/or with said trailer an angle smaller than a first threshold value and/or larger than a second threshold value and being switched on when said angle exceeds again said first threshold value or goes below said second threshold value, due to suitable actuators, comprising angle detection means between the steering wheels and the vehicle axle and means apt to correlate said angle between the steering wheels and the axle of the vehicle with the angle comprised between the cardan and said vehicle and/or trailer, characterised in that the angle (ε) which must be compared to the threshold value is calculated according to the relationship:

ε=δ−arcsen(m/l*senδ) (1)

wherein:

m=length of an arm of the cardan

l=length of another arm of the cardan

δ=angle between the steering wheels and the vehicle axle. subclaims describe preferred features of the invention.

Further features and advantages of the invention will anyhow be more apparent from the following detailed description of a preferred embodiment, given by mere way of non-limiting example and illustrated in the accompanying drawings, wherein:

FIG. 1 is a schematic side view of a vehicle with trailer according to the present invention;

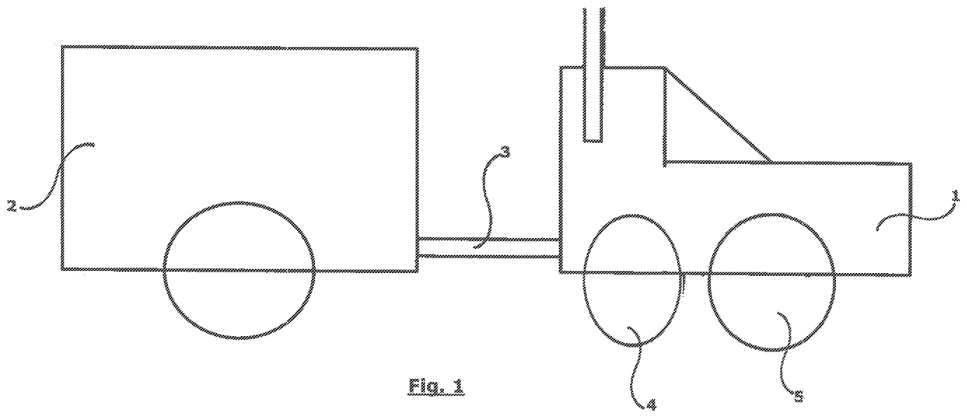

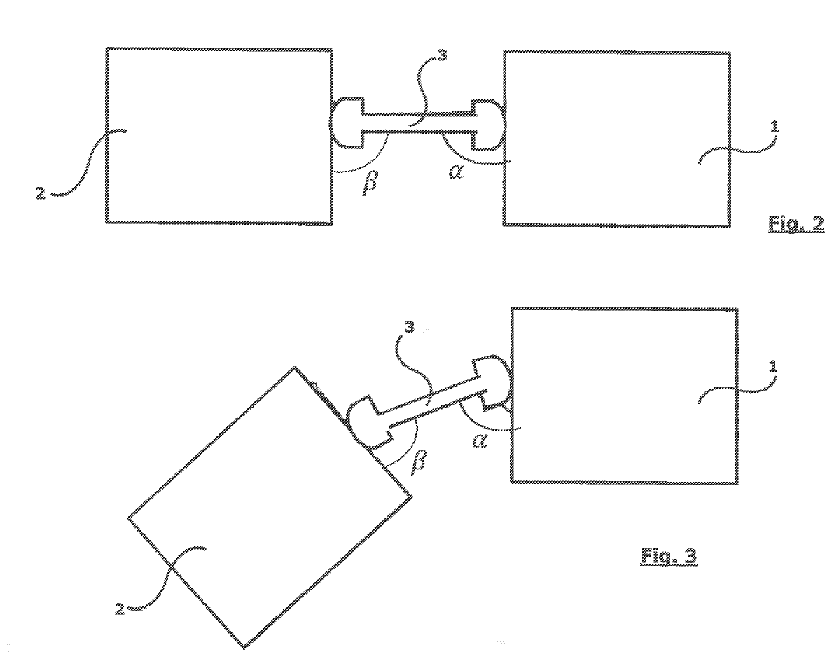

FIG. 2 is a schematic plan view of a vehicle with trailer according to the present invention, showing the vehicle and the trailer in rectilinear movement;

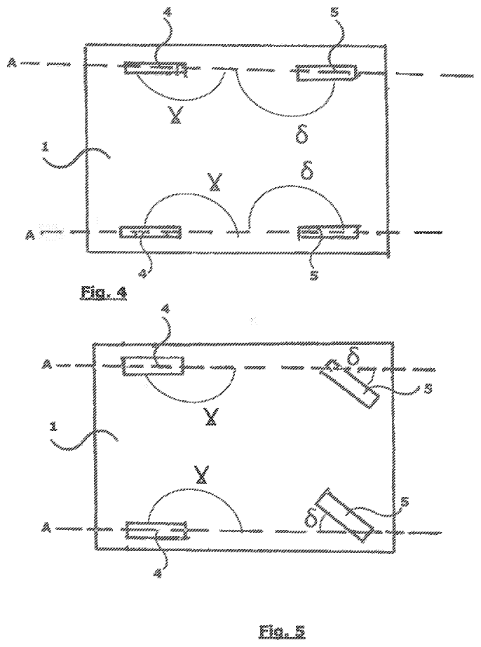

FIG. 3 is a view similar to FIG. 2, but during a curve of the vehicle;

FIG. 4 is a schematic plan view of the bottom of a vehicle, according to the present invention, during the straight run;

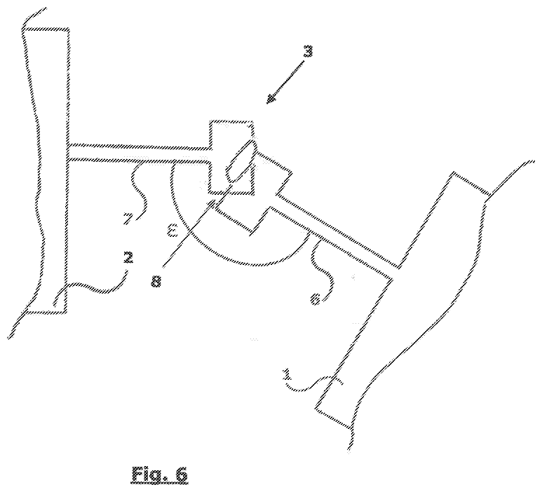

FIG. 5 is a view similar to FIG. 4, but during a curve of the vehicle;

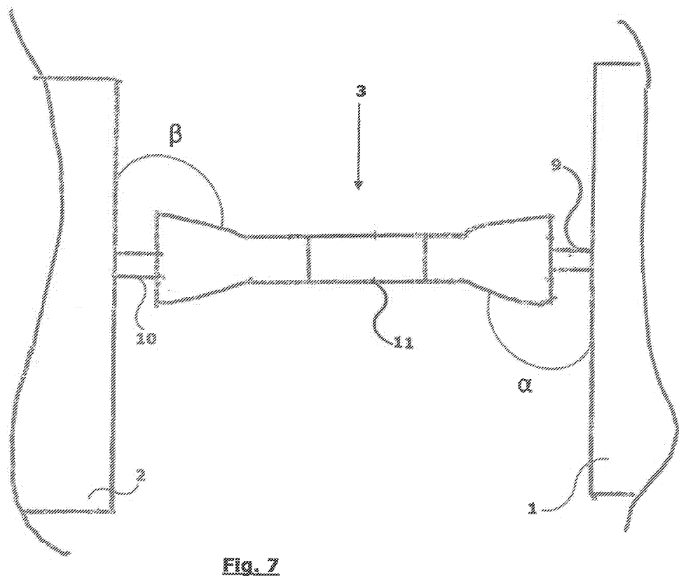

FIG. 6 is a schematic view of an embodiment of the present invention, with the cardan being highlighted; and

FIG. 7 is a view similar to FIG. 6, but with the use of a telescopic cardan.

The description that follows is directed to the exemplary case of a tractor with a trailer. The trailer, in turn, may contain operating units, such as a spraying pump, a lawn mower, or the like. Preferably, said trailer is a towed load. Obviously, despite the above, the present invention is not limited to the case of the tractor with towed trailer, but it comprises any vehicle with a trailer joined together with a cardan. It is understood that, if the trailer is towed, the towing action of the trailer is not performed by the cardan—which only realises a functional connection for the energy transmission to the machines on the trailer —, but by hooking one eye of the drawbar of the trailer to a pin of the tractor.

FIG. 1 shows a tractor 1, coupled to a trailer 2 through a cardan 3. The tractor 1 includes rear steering wheels 4 and front steering wheels 5.

The cardan 3 can be of the normal type, as shown in FIG. 6, or of the telescopic type, as shown in FIG. 7.

The normal cardan comprises two arms 6, 7, which are joined in the joint 8.

The telescopic cardan comprises two arms 9, 10, carried by the vehicle 1 and the trailer 2, respectively, each joined by a respective cardan joint to an elastic joint 11, able to lengthen and shorten telescopically, depending on the direction and intensity of stresses.

FIG. 2 schematically shows the linear driving of the vehicle 1 and the trailer 2. The angles α, between the vehicle 1 and the cardan 3, and the angle β between the trailer 2 and the cardan 3, are both approximately 90°. FIG. 3 shows the situation in which the vehicle 1 and/or the trailer 2 begin to curve and the angles α and β vary due to the curve. FIGS. 4 and 5 illustrate the same situation, in a (bottom) plan view on the vehicle floor pan 1. In FIG. 4 the wheels 4, 5 are straight and the angles γ and δ, which form, respectively, with the axes A, are 180°. FIG. 5 shows that, while the angles γ comprised by the non-steering wheels 4 with the axle A are the same, i.e. 180°, the angles δ comprised by the steered wheels 5 with the same axle A are very different.

The inventors of the present invention have performed extensive studies, according to which they have come to the surprising conclusion that the angles δ are in a direct biunivocal relationship with the angles α and β, respectively. On the basis of this finding, the present invention has been accomplished.

As mentioned previously, angle δ detection means are mounted on the vehicle 1, between one or both of the steered wheels and the axle A of the vehicle. The detected data is sent to a computer, which uses it to derive the angle α between the vehicle 1 and the cardan 3, and the angle β between the trailer 2 and the cardan 3. When the value of one or both of the angles α and β goes below a first threshold value (for example 35°) or above a second threshold value (for example 145°), the computer sends a signal to the actuator of the power take-off, which determines its switching off. When one or both of the angles α and β go above a threshold value (for example 35°) or below another threshold value (for example 145°), another signal is sent to the actuator of the power take-off, and the latter is switched on again.

A preferred embodiment is illustrated with reference to FIG. 6. FIG. 6 shows a cardan 3, formed by two arms 6 from the vehicle 1 and 7 from the trailer 2, joined in the joint 8. The arms 6, 7 form an angle ε therebetween. To obtain, from the angle ε, which is the angle that must remain between the two threshold values, for example 35° and 145°, at each instant, the processing system on the vehicle 1 according to the present invention starts from some data. Firstly, the length of the arms 6, 7, known at the time of construction or that is adjustable, in the case of using different trailers from time to time. Secondly, the angle δ value is used, which is detected by the detection means on the vehicle 1, according to the present invention.

If [symbol] is the length of the arm 6 and m is the length of the arm 7, the relationship used by the computer to obtain the value of ε is:

ε=δ−arcsen(m/ [symbol] *senδ) (1)

In fact, the vehicle 1 and the trailer 2 form an angle therebetween, the sides of which can be joined together to form a triangle, to which the trigonometry rules can be applied. The angles of the triangle are 180°−δ, ε and ζ. The height of such a triangle is Isenζ, which is equal to msenδ. It follows that ζ=arcsen (m/l*senδ). Since the sum of inner angles of a triangle is 180°, it follows that ε=180°−δ−ζ. Substituting the previous definition of ζ we obtain the relationship (1), which allows to obtain the value of ε as δ varies.

In the case illustrated in FIG. 7, with a telescopic cardan 3, the same relationship will be true for each of the angles α and β; however, it will be necessary to take in account also the changeable length of the arms 9 and 10, for which it will be appropriate to operate with a prudential value, to consider the most unfavorable conditions, or have a sensor for the length of each of arms 9 and 10, which is inserted in the calculation in the relationship similar to the relationship (1).

The cases illustrated above can also be reported in the case of angles on the cardan 3 not created by the steering action, but rather by a climb or a descent. In this case, the angle formed by the wheels with the long axle of the vehicle 1 will not detected; on the contrary, the angle formed by the vehicle 1 with the just previous road section will be detected. This data can be detected continuously by an electronic level. Therefore, a preferred embodiment of the present invention provides, in addition to the angle detection device of the wheels 5 with respect to axle A, also an electronic level for the continuous detection of the angle between the travelled road section and the just previous one. Preferably, the delay according to which the position of the previous road section is calculated, is equal to the time since the passage of the vehicle 1 until the passage of the trailer 2.

According to the above, the present invention allows to realize a vehicle 1 with trailer 2 connected thereto with a cardan 3, which preserves the cardan 3 by switching off the power take-off, when a certain angle in one direction is exceeded, and by switching it on again, when this angle threshold is exceeded in the opposite direction, so as to maximise the exploitation of the power and to avoid distractions of the operator for this operation. This increases safety and performance compared to the prior art tractors.

This is true, in particular, in the case in which the trailer 2 is a towed load and where the operator can safely forget the power take-off at all.

The present invention has hereto been described in relation to a tractor which tows another agricultural machine, but it is clear that the disclosed and claimed object matter is equally applicable to any vehicle that transport, thanks to a cardan, a trailer.

The present invention also allows to prevent the crankcase of the cardan 3 from being damaged with damages linked to operating the cardan 3 a little above the permitted angles, but for short periods of time, which do not damage the cardan 3, but which can release the crankcase, necessitating its replacement to meet the requirements of the occupational safety laws.

It is understood, however, that the invention is not to be considered as limited by the particular arrangement illustrated above, which represents only an exemplary embodiment of the same, but different variants are possible, all within the reach of a person skilled in the art, without departing from the scope of the invention itself, as defined by the following claims.

### LIST OF REFERENCE NUMERALS

1 Vehicle
2 Trailer
3 Cardan
4 Non-steering wheels (of 1)
5 Steering wheels (1)
6 Arm (of 3)
7 Arm (of 3)
8 Joint (of 3)
9 Arm (of 3)
10 Arm (of 3)
11 Elastic joint
α Angle
β Angle
γ Angle
δ Angle
ε Angle

1) Vehicle (1) with trailer (2) operatively connected thereto with a cardan (3), said cardan (3) comprising a power take-off, said power take-off being switched off when said cardan (3) forms with said vehicle (1) and/or with said trailer (2) an angle (α; β) smaller than a first threshold value and/or larger than a second threshold value and being switched on when said angle exceeds again said first threshold value or goes below said second threshold value, due to suitable actuators, comprising angle (δ) detection means between the steering wheels (5) and the vehicle axle (A) and means apt to correlate said angle (δ) between the steering wheels (5) and the axle (A) of the vehicle (1) with the angle (α; β; ε) comprised between the cardan (3) and said vehicle (1) and/or the trailer (2), to characterised in that the angle (ε) which must be compared to the threshold value is calculated according to the relationship:
ε=180°−δ−arcsen(m/ [symbol] *senδ) (1)
wherein:
m=length of an arm of the cardan
l=length of another arm of the cardan
δ=angle between the steering wheels and the vehicle axle.

2) Vehicle as in claim 1), characterised in that it consists of a tractor.

3) Vehicle as in claim 1), characterised in that said trailer is a towed load.

4) Vehicle as in claim 1), characterised in that said cardan (3) is a telescopic cardan (3).

5) Vehicle (1) as in claim 1), characterised in that said first threshold value is 35° and said second threshold value is 145°.

6) Vehicle as in claim 1), characterised in that it furthermore comprises an electronic level.
